(19) United States
(12) Patent Application Publication
(10) Pub. No.: US 2013/0212693 A1
(43) Pub. Date: Aug. 15, 2013

(54) ANONYMOUS WHISTLE BLOWER SYSTEM WITH REPUTATION REPORTING OF ANONYMOUS WHISTLE BLOWER

(71) Applicant: UNILOC LUXEMBOURG S.A., (US)

(72) Inventor: Craig S. ETCHEGOYEN, Newport Beach, CA (US)

(73) Assignee: UNILOC LUXEMBOURG S.A., Luxembourg (LU)

(21) Appl. No.: 13/742,972

(22) Filed: Jan. 16, 2013

Related U.S. Application Data
(60) Provisional application No. 61/599,274, filed on Feb. 15, 2012.

(30) Foreign Application Priority Data
Apr. 24, 2012 (AU) 2012100470

(51) Int. Cl. G06F 21/60

(52) U.S. Cl. CPC G06F 21/60
USPC 726/26

(57) ABSTRACT

Reputations of anonymous sources of information are managed by associating the reputations with devices from which the information is received rather than from the human individuals using those devices. The devices are recognized using a one-way identifier, such as a digital fingerprint, such that the source device cannot be used to readily identify the source device or its user(s) but all items of information received from the same source device can be readily recognized. Feedback from other devices is accumulated and used to assess trustworthiness of the source device and reputation data representing such trustworthiness is published along with the information received from the source device.

This application claims priority to U.S. Provisional Application No. 61/599,274, which was filed Feb. 15, 2012, and which is fully incorporated herein by reference.

### BACKGROUND OF THE INVENTION

1. Field of the Invention

The present invention relates generally to network-based computer services and, more particularly, methods of and systems for accepting reports from anonymous reporters while tracking reputations of individual reporters.

2. Description of the Related Art

Systems by which individuals can report incidents benefit from protecting the anonymity of the reporting individuals. This is particularly true of whistle blowing systems in which individuals are encouraged to report wrong-doing of others. Fear of retribution can discourage such reporting. However, the reporting of wrong-doing is highly valuable to some parties, such as government watchdog agencies, who would like to see wrong-doing reduced and prevented. But unless the whistleblower can remain anonymous, actual retribution or even alleged retribution can lead to costly legal proceedings and unnecessary demonstrations of hostility. See, for example, the case of Seater v. Southern California Edison Co., ARB Case No. 96-013, ALJ Case No. 95-ERA-13, Sep. 27, 1996.

On the other hand, systems such as the Internet allow virtually anyone to write or report anything without being limited by facts or honesty, and without requiring the reporter to reveal his or her identity. Although it is generally wise to consider the reputation of the source of information in evaluating its relevance and import, most of the automated search engines that crawl the Internet for information are not so discriminating.

Pseudonymity, a close relative of anonymity, has proliferated with the popularity of Internet communications. Many people prefer to adopt a pseudonym when posting opinions, criticisms, and other written expressions on public websites. Pseudonyms are also popular on social networking sites, which enable users to shield their true identity behind the guise of an alter ego. In fact, it is so easy for users to register new accounts under pseudonyms that many users have create multiple accounts on the same site, each under a different pseudonym, to further distribute wide ranging views and criticisms, in effect protecting the user's anonymity behind a cloud of pseudonyms. Some users even exploit their pseudonym portfolio professionally by proliferating contrived criticisms or false reviews (i.e. stuffing the ballot box) for the purpose of artificially boosting or damaging the rating or reputation of a product, service, individual, or company that is advertised online.

Naturally, anonymity and reputation are at opposite ends. Since an individual's reputation is intrinsically tied to the individual, knowing the individual's reputation requires knowing the individual, and this makes it difficult to strike a safe and meaningful balance on the anonymity-reputation spectrum.

What is needed is a way to evaluate and report reputations of anonymous reporters of information.

### SUMMARY OF THE INVENTION

In accordance with the present invention, reputations of anonymous sources of information are managed by associating the reputations with devices from which the information is received rather than from the human individuals using those devices. The devices are recognized using a one-way identifier, such as a digital fingerprint or an irreversible hash of one or more configuration or usage characteristics of each device. The identifier is one-way in that a given device always produces the same identifier, and can therefore be recognized in multiple transactions, but the identifier cannot readily be used to deduce the identity of the device or its user.

When information, such as an incident report, is received by an information management server, the digital fingerprint of the source device is received and associated with the information. The information is published in association with reputation data of the source device representing a measure of trustworthiness of the source device.

When viewing information from the source device, other devices can be used to send feedback data to the information management server. The feedback data can represent confirmation, corroboration, dispute, or appreciation of the published information as illustrative examples. The reputation data of the source device is derived from all such feedback data received from all information received from the source device.

While the identifier of the source device cannot be used to readily identify the source device or its user, the identifier can be used to identify all items of information received from the same source device. Accordingly, reputation data is associated with a single, specific, yet anonymous device, regardless or the number of anonyms or pseudonyms associated with the items of information.

The result is that individuals can submit information without fear of reprisals or retribution for such submissions while consumers of the information still retain the benefit of being able to ferret out unreliable sources of information.

### BRIEF DESCRIPTION OF THE DRAWINGS

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims. Component parts shown in the drawings are not necessarily to scale, and may be exaggerated to better illustrate the important features of the invention. In the drawings, like reference numerals may designate like parts throughout the different views, wherein:

FIG. 1 is a diagram showing a server computer that receives reports and feedback from a number of client devices through a wide area network to aggregate anonymous incident reports and manage and report reputations of anonymous reporters in accordance with one embodiment of the present invention.

FIG. 2 is a transaction diagram illustrating one embodiment according to the invention of a method by which the server computer of FIG. 1 receives an anonymous incident report from a computing device of FIG. 1.

FIG. 3 is a block diagram of a device data record associated with the reporting client device of FIG. 1 in greater detail.

FIG. 4 is a block diagram of a report record representing an anonymous report of an incident.

FIG. 5 is a transaction diagram illustrating one embodiment according to the invention of a method by which the server computer of FIG. 1 receives anonymous feedback regarding an anonymous incident report from a computing device of FIG. 1.

FIG. 6 is a block diagram showing the server computer of FIG. 1 in greater detail.

### DETAILED DESCRIPTION

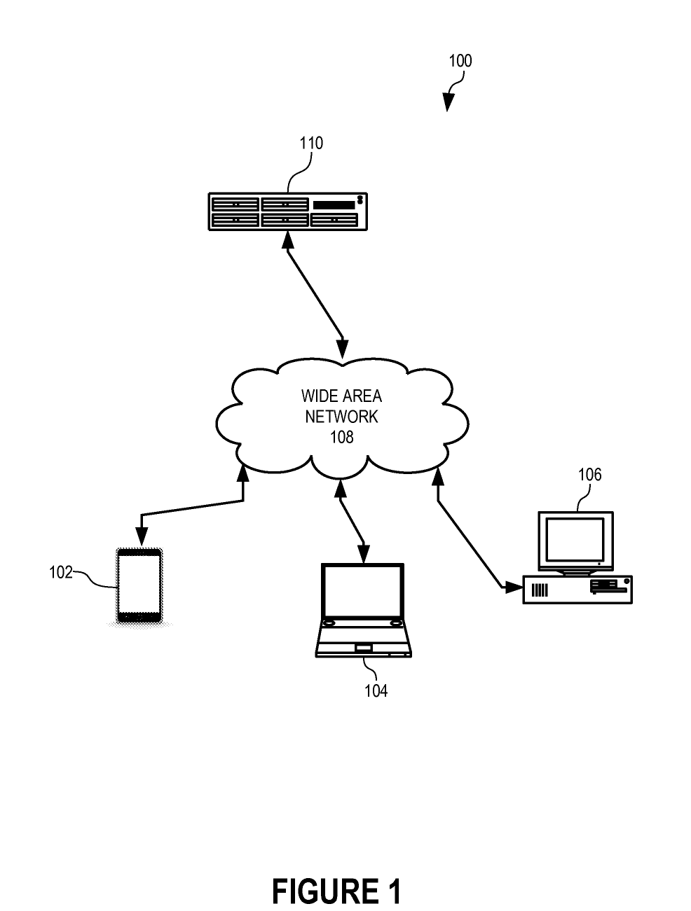

In accordance with the present invention, a server computer 110 (FIG. 1) maintains anonymity of sources of incident reports received from client devices 102-106 while also evaluating and reporting reputations of those same sources. In particular, server computer 110 associates each reporting device with its digital fingerprint. Digital fingerprints are known and are described, e.g., in U.S. Pat. No. 5,490,216 (sometimes referred to herein as the '216 patent), and in related U.S. Patent Application Publications 2007/0143073, 2007/0126550, 2011/0093920, and 2011/0093701 (the “related applications”), the descriptions of which are fully incorporated herein by reference.

Generally, a digital fingerprint is unique to a given device but does not, in and of itself, identify the device. The digital fingerprint only identifies a device when a match is found among known digital fingerprints of known devices. Since people tend to use just one or a few computing devices, reputations can be tracked for individual devices as a proxy for the individual user's reputation. In essence, reputations are tracked for individual devices and represent the trustworthiness of reports received from the respective devices.

In general, the device fingerprint comprises a bit string or bit array that includes or is derived from user-configurable and non-user-configurable data specific to the computing device 102, 104, 106 being fingerprinted, i.e., the target device. Non-user-configurable data includes data such as hardware component model numbers, serial numbers, and version numbers, and hardware component parameters such as processor speed, voltage, current, signaling, and clock specifications. User-configurable data includes data such as registry entries, application usage data, file list information, and MAC address. In one embodiment, the target device can also include non-user configurable data such as manufacture name, model name, and device type.

Generation of the device fingerprint includes a combination of operations on the data specific to the target device, which may include processing using a combination of sampling, concatenating, appending (for example, with a nonce value or a random number), obfuscating, hashing, encryption, and/or randomization algorithms to achieve a desired degree of uniqueness. For example, the desired degree of uniqueness may be set to a practical level such as 99.999999% or higher, to achieve a probability of less than 1 in 100,000,000 that any two of the audio transceiver computing devices will generate identical fingerprints. In one embodiment, the desired degree of uniqueness may be such that the device fingerprint generated is unlike any other device fingerprint generatable responsive to a request for the fingerprint.

Server computer 110 receives incident reports from a number of client devices 102-106 through a wide area network, which is the Internet in this illustrative embodiment. In other embodiments, incident reports can be received through local area networks or larger intranets.

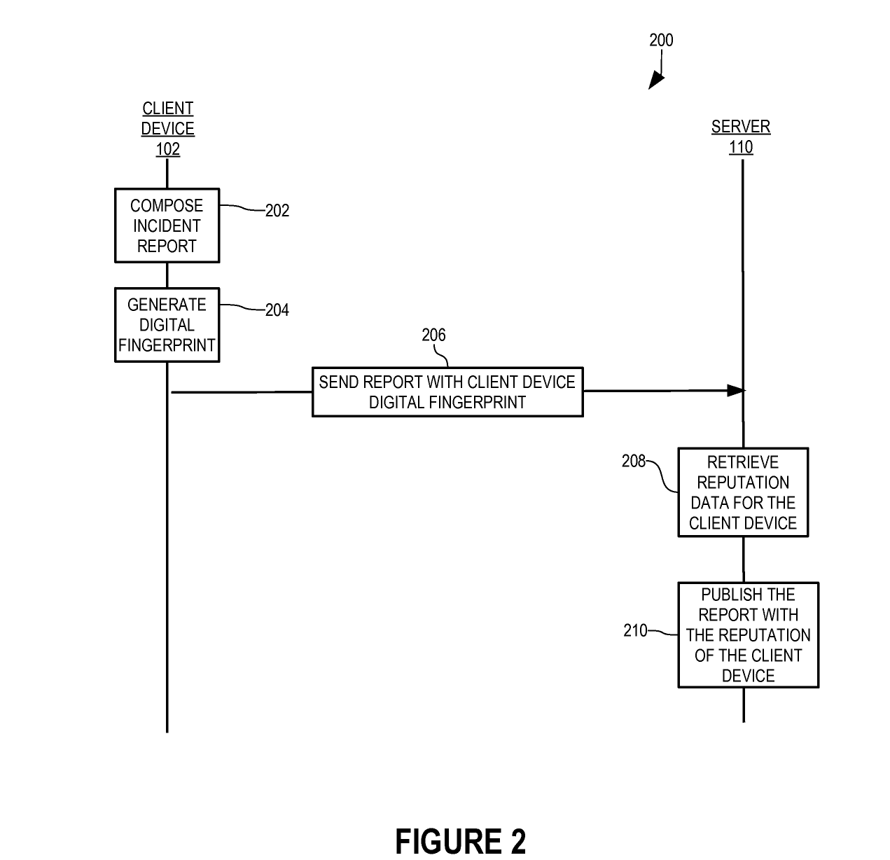

Transaction flow diagram 200 (FIG. 2) illustrates the anonymous reporting of an incident by client computer 102 (FIG. 1) to server computer 110 in such a manner that the reputation of client computer 102 can be maintained without directly identifying client computer 102 and, more importantly, the person using client computer 102 to report the incident. It should be appreciated that, while client device 102 is described as the source of the subject incident report in this illustrative example, the following description of reporting by client device 102 is equally applicable to reporting by any other client device, including client devices 104-106, unless otherwise noted herein.

In step 202, the human user of client device 102 composes an incident report using conventional user interface techniques involving physical manipulation of one or more user input devices of client device 102. The user interface can be provided by software and other logic installed in client device 102 or by software provided by server computer 110 in a thin client executing in client device 102, e.g., through a conventional web browser.

In step 204, client device 102 generates a digital fingerprint of itself in a conventional manner. In one embodiment, generation of the digital fingerprint in this step is triggered by the software of the user interface in response to an indication from the user that the user intends to transmit an incident report to the server 110. The digital fingerprint may be retrieved from a memory resident on the computing device or accessible by server 110, or the digital fingerprint may be newly generated by a fingerprinting algorithm that has access to machine parameters of client device 102, which machine parameters are used as input to the fingerprinting algorithm. In an embodiment where the fingerprint is retrieved from memory, such retrieval may be contingent on the recency of the fingerprint, to ensure that fingerprints are relatively fresh. If the age of a fingerprint exceeds some threshold, then a fresh fingerprint may be generated using the algorithm.

In step 206, client device 102 sends the incident report composed in step 202 along with the digital fingerprint generated or obtained in step 204 to server computer 110.

In step 208, server computer 110 retrieves data representing a reputation associated with the digital fingerprint received in step 206. In a case where no reputation has been previously established, an arbitrary reputation maybe assigned, depending on the will of the programmer. For example, if reputations are graded according to a scale of 0 to 99, a new reputation may be given a neutral value, such as 50.

In step 210, server computer 110 publishes the incident report received in step 206 along with the reputation retrieved in step 208. As a result, the incident report is publicly available and is associated with a reputation accumulated by client device 102 while the identity of client computer 102 is not publicly available.

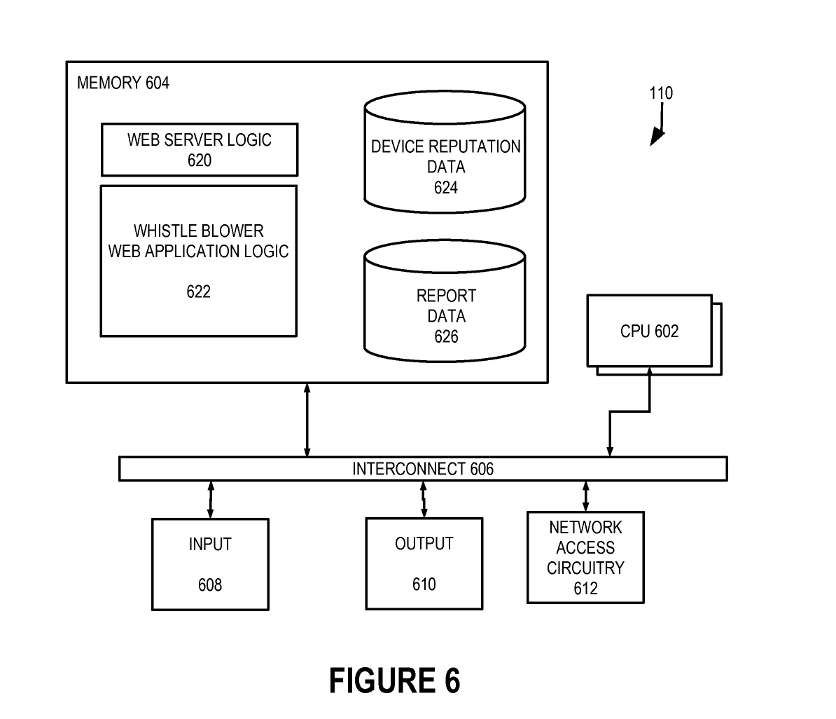

In this illustrative embodiment, server computer 110 publishes the incident report in step 210 by forming a report data record 400 (FIG. 4) representing the received incident report and storing report data record 400 in report data 624 (FIG. 6), which is described more completely below.

Report data record 400 (FIG. 4) includes a source device 402, which is data identifying a device data record, such as device data record 300 for example, as representing the client device from which the subject incident report is received. Device data record 300 is described more completely below.

Report metadata 404 includes data regarding the context of the subject incident report, such as date and time the report was made and geolocation data for example.

Report body 406 includes a textual body of the subject incident report as composed by the user of client device 102 in step 202 (FIG. 2).

Attachment 408 can include one or more data files that can provide additional information regarding the reported incident. For example, attachment 408 can include one or more photographs of the incident or video of the incident or audio of the incident or of an oral report of the incident by the user or any combination of these and other data files.

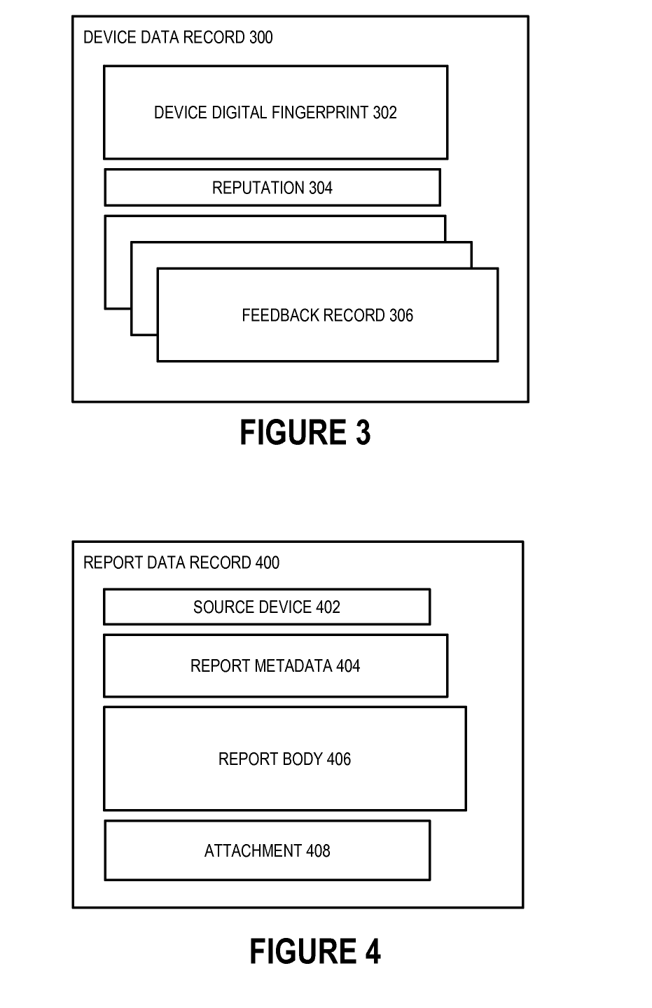

As noted above, source device 402 identifies a device data record, such as device data record 300 (FIG. 3), as representing the client device from which the incident report of report data record 400 was received.

Device digital fingerprint 302 (FIG. 3) is the digital fingerprint associated with the received incident report as is used by server computer 110 to retrieve device data record 300 as representing the source client device.

Reputation 304 represents a cumulative reputation of the device represented by device data record 300, e.g., client device 102 in this illustrative example. The cumulative reputation can be represented in any of a wide variety of ways. For example, the cumulative reputation can be represented as a single numerical score of trustworthiness that can be normalized to a range of zero to one hundred percent. Alternatively, the cumulative reputation can have multiple component scores. For example, a trustworthiness score can represent, inversely, the number or percentage of times a report from client device 102 was disputed; an importance score can represent a number or percentage of times incident reports from client device 102 have resulted in remedial action; and an activity score can represent the overall volume or frequency of incident reports received from client device 102.

Device data record 300 includes a number of feedback records 306. Each of feedback records 306 represents an item of feedback received for an incident report received from client device 102. Feedback records 306 can have generally the same structure as report data record 400 (FIG. 4), except that report metadata 404 of a feedback record 306 identifies a report data record 400 to which feedback record 306 corresponds.

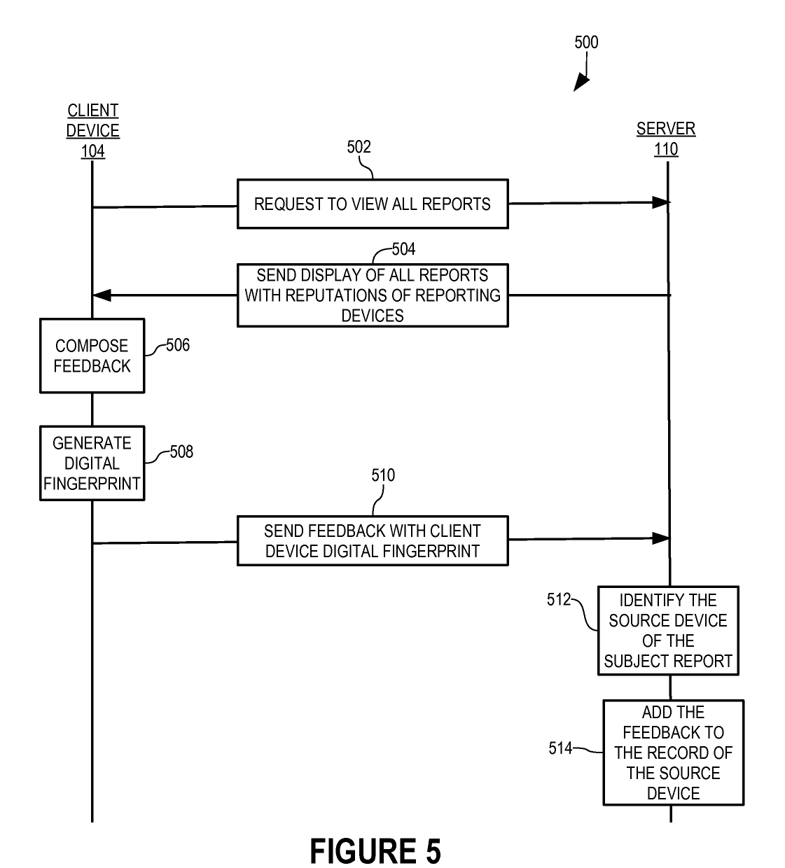

Transaction flow diagram 500 (FIG. 5) illustrates cooperation between server computer 110 and a client device, e.g., client device 104, to receive and process feedback regarding an incident report to thereby maintain data representing the reputation of the source device of the incident report in accordance with the present invention. It should be appreciated that any of a number of client devices can request to view incident reports and submit feedback in the manner described herein. Accordingly, the following description of the behavior of client device 104 is equally applicable to client devices 102 and 106 except as otherwise noted herein. Normally, a client device would not submit feedback to an incident report submitted by the same client device, and such is prevented in some embodiments.

In step 502, client device 104 sends to server computer 110 a request to view incident reports. In this illustrative embodiment, the request is in the form of a URL that is directed to server computer 110.

In step 504, server computer 110 sends a web page that includes a view of the requested incident reports to client device 104. In addition to include the substance of a number of incident reports, server computer 110 includes information regarding the cumulative reputations of the respective source client devices of the incident reports. Client device 104 displays the received web page in a conventional web browser in this illustrative embodiment. The user of client device 104 can see the reputations of the sources of the various incident reports and can view the incident reports in the context of those reputations. At the same time, there is nothing in the web page that can be used to identify specific individuals as sources of the incident reports. Moreover, server computer 110 does not maintain any information by which even an unauthorized user with access to data stored within server computer 110 could determine the identity of any individual submitting an incident report in the manner described herein.

The web page provides links or a user interface, or both, by which the user of client device 104 can compose feedback regarding any of the incident reports represented in the web page. In step 506, the user of client device 104 composes such feedback, involving physical manipulation of one or more user input devices of client device 104 using conventional user interface techniques. Each item of feedback identifies the incident report to which it pertains and includes a type that is selected by the user of client device 104 in this illustrative embodiment. A type may be, for example, a confirmation, a dispute, or an appreciation. In addition, people in a position to take remedial action for reported incidents can be provided a mechanism to indicate to server computer 110 that remedial action has been taken with respect to a specific reported incident. The feedback can also include a textual body explaining the nature of the feedback as well as attached data files in the manner described above with respect to report data record 400 (FIG. 4).

In step 508 (FIG. 5), client device 104 generates its own digital fingerprint in the manner described above with respect to step 204 (FIG. 2).

In step 510 (FIG. 5), client device 104 sends the feedback composed in step 506 and the digital fingerprint generated in step 508 to server computer 110.

In step 512, server computer 110 identifies the source client device of the subject incident report. In particular, the feedback received in step 510 specifies the incident report to which it pertains. Source device 402 (FIG. 4) of the report data record 400 representing the subject incident report identifies a device data record 300 associated with the source client device.

In step 514 (FIG. 5), server computer 110 forms a feedback record 306 representing the received feedback and includes the newly created feedback record 306 in the device data record 300 identified in step 512. In addition, server computer 110 updates reputation 304 to include information from the newly added feedback record 306. In an alternative embodiment, server computer 110 evaluates reputation 304 only when needed to provide a web page showing one or more incidents reported by the client device represented by device data record 300.

After step 514, processing according to transaction flow diagram 500 completes. Multiple items of feedback from multiple client devices accumulate to provide a substantially accurate representation of the overall reputation of individual client devices among other client devices of the community collectively. In essence, the reputation of the client devices serve as a proxy for the reputations of the client devices' users.

It is not a critical assumption that each client device has a single user for the reputation of the client device to be useful and meaningful. It is helpful to consider a client device in a publicly accessible location such as a public library—such a client device can have any number of users who can submit incident reports. If all such users of the client device in the public library are trustworthy, the client device's reputation will so indicate. On the other hand, if many users of the client device in the public library are untrustworthy, feedback for the incident reports submitted through that client device will harm the reputation of the client device. Essentially, the reputation of a client device is an accumulation of the reputations of all users of the client device, weighted by the frequency with which each user of the client device submits incident reports.

In another embodiment, the frequency with which any single computing device 102-106 submits incidence reports can affect the reputation 304 of that device, if the frequency is above or below a predetermined threshold maintained by server 110. In another embodiment, the total number of incident reports submitted by a client device can affect the reputation 304 of a computing device, according to thresholds and scoring rules determined by the programmer. In other embodiments, statistics such as incident reporting frequency and total incident reports can comprise a feedback record 306.

Client devices 102-106 can be any conventional, network-capable computing device that includes a web browser and sufficient hardware and software to provide user interfaces by which users of the client devices can compose incident reports and feedback in the manner described herein.

Server computer 110 is shown in greater detail in FIG. 6. Server computer 110 includes one or more microprocessors 602 (collectively referred to as CPU 602) that retrieve data and/or instructions from memory 604 and execute retrieved instructions in a conventional manner. Memory 604 can include generally any computer-readable medium including, for example, persistent memory such as magnetic and/or optical disks, ROM, and PROM and volatile memory such as RAM.

CPU 602 and memory 604 are connected to one another through a conventional interconnect 606, which is a bus in this illustrative embodiment and which connects CPU 602 and memory 604 to one or more input devices 608, output devices 610, and network access circuitry 612. Input devices 608 generate signals in response to physical manipulation of input devices 608 by the user and can include, for example, a keyboard, a keypad, a touch-sensitive screen, a mouse, a microphone, and one or more cameras. Output devices 610 can include, for example, a display—such as a liquid crystal display (LCD)—and one or more loudspeakers. Since server computer 110 is a server computer, input devices 608 and output devices 610 can be omitted. Network access circuitry 612 sends and receives data through computer networks such as wide area network 108 (FIG. 1), the Internet, and mobile device data networks, for example.

A number of components of portable computing device 102 are stored in memory 604. In particular, web server logic 620 and whistle blower web application logic 622 are each all or part of one or more computer processes executing within CPU 602 from memory 604 in this illustrative embodiment but can also be implemented using digital logic circuitry. As used herein, “logic” refers to (i) logic implemented as computer instructions and/or data within one or more computer processes and/or (ii) logic implemented in electronic circuitry. Whistle blower web application logic 622 includes logic and content (i) to be sent by web server logic 620 to client devices in response to request described above and (ii) that specifies behavior of server computer 110 in response to incident reports and feedback received from client devices.

In addition, device reputation data 624 and report data 626 are data stored persistently in memory 604. Device reputation data 624 includes device data records such as device data record 300 (FIG. 3). Report data 626 includes report data records such as report data record 400 (FIG. 4). In this illustrative embodiment, device reputation data 624 and report data 626 are each organized as one or more databases.

The above description is illustrative only and is not limiting. The present invention is defined solely by the claims which follow and their full range of equivalents. It is intended that the following appended claims be interpreted as including all such alterations, modifications, permutations, and substitute equivalents as fall within the true spirit and scope of the present invention.

What is claimed is:

1. A method for managing reputations of anonymous sources of information, the method comprising:
receiving information from an anonymous user via a remotely located source device through a computer network, wherein the information includes a device fingerprint generated by a combination of operations on data specific to the remotely located source device;
deriving reputation data that represents a measure of trustworthiness of information received from the remotely located source device from feedback received from other remotely located devices, wherein the feedback pertains to one or more items of information previously received from the remotely located source device; and
publishing the information received from the remotely located source device along with the reputation data.

2. The method of claim 1 further comprising:
sending the information as published to a remotely located viewing device;
receiving feedback data from the remotely located viewing device wherein the feedback data is responsive to the information as published; and
updating the reputation data to produce updated reputation data in accordance with the feedback data.

3. The method of claim 2 further comprising:
republishing the information with the updated reputation data.

4. The method of claim 1 wherein the information is a report of an incident.

5. A computer system comprising:
at least one processor;
a computer readable medium that is operatively coupled to the processor;
network access circuitry that is operatively coupled to the processor; and
information management logic (i) that executes in the processor from the computer readable medium and (ii) that, when executed by the processor, causes the computer to manage reputations of anonymous sources of information by at least:
receiving information from an anonymous user of a remotely located source device through a computer network, wherein the information includes a device fingerprint generated by a combination of operations on data specific to the remotely located source device;
deriving reputation data that represents a measure of trustworthiness of information received from the remotely located source device from feedback received from other remotely located devices, wherein the feedback pertains to one or more items of information previously received from the remotely located source device; and
publishing the information received from the remotely located source device along with the reputation data.
